(19) United States
(12) Patent Application Publication
(10) Pub. No.: US 2009/0290347 A1
(43) Pub. Date: Nov. 26, 2009

(54) Angled LED Light Module

(76) Inventor: Pervaiz Lodhie, Rolling Hills, CA (US)

Correspondence Address: Alonzo & Associates, 311 Main St, Suite G, El Segundo, CA, 90245, US

(21) Appl. No.: 12/137,337

(22) Filed: Jun. 11, 2008

Related U.S. Application Data
(60) Provisional application No. 61/055,835, filed on May 23, 2008.

(51) Int. Cl. F21V 21/00

(52) U.S. Cl. 362/249.02

(57) ABSTRACT

An angled LED light module comprising at least two boards arranged at an angle relative to each other; and a plurality of LED bulbs mounted on the at least two boards, wherein the at least two boards and the plurality of LED bulbs form a single light source. In one aspect, the at least two boards are printed circuit boards. In one aspect, the angled LED light module comprises two stages.

### CLAIM OF PRIORITY UNDER 35 U.S.C. §119

The present Application for Patent claims priority to Provisional Application No. 61/055,835 entitled Angled LED Light Module filed May 23, 2008, and assigned to the assignee hereof and hereby expressly incorporated by reference herein.

### FIELD

This disclosure relates generally to lighting sources. More particularly, the disclosure relates to a Light-Emitting Diode (“LED”) lighting source.

### BACKGROUND

LED bulbs are light sources that use semiconductor materials rather than filaments to emit light. LED bulbs are generally more efficient light sources than incandescent light bulbs because LED bulbs are nearly monochromatic and emit light within a very narrow range of wavelengths. LED bulbs also generally last many times longer than incandescent light bulbs.

Street light posts can be fitted with light sources to illuminate a street, parking lot, walkway, a building, etc. Historically, incandescent lights with filament type bulbs have been used for illumination. Since incandescent light bulbs illuminate radially outward, the illumination is distributed approximately uniformly in all directions. Additionally, incandescent lights typically have shortened life-spans than light modules using LED bulbs. Incandescent lights are typically less energy efficient than light modules using LED bulbs.

### SUMMARY OF THE DISCLOSURE

According to one aspect, a Light-Emitting Diode (“LED”) light comprising at least two printed circuit boards arranged at an angle relative to each other; and a plurality of LED bulbs mounted on the at least two printed circuit boards, wherein the at least two printed circuit boards and the plurality of LED bulbs form a single light source.

According to another aspect, a LED light module comprising a top stage comprising a first set of plurality of plates; a bottom stage comprising a second set of plurality of plates; a first plurality of LED bulbs mounted on the first set of plurality of plates; and a second plurality of LED bulbs mounted on the second set of plurality of plates, wherein at least one of the first set of plurality of plates is arranged at an angle relative to another of the first set of plurality of plates, and wherein at least one of the second set of plurality of plates is arranged at an angle relative to another of the second set of plurality of plates to form a single light source.

It is understood that other embodiments will become readily apparent to those skilled in the art from the following detailed description, wherein it is shown and described various embodiments by way of illustration. The drawings and detailed description are to be regarded as illustrative in nature and not as restrictive.

### BRIEF DESCRIPTION OF THE DRAWINGS

FIG. 1 is a front view of an example of a LED light module.

FIG. 2 shows an example of the relationship of two printed circuit boards.

FIG. 3 shows an example of the relationship of two other printed circuit boards.

FIG. 4 shows an example of the relationship of yet two other printed circuit boards.

FIG. 5 is a front view of an example of a LED light module with printed circuit boards with different shapes.

FIGS. 6 and 7 illustrate two examples of two LED light modules with partially populated printed circuit boards.

FIG. 8 illustrates an example of a two stage LED light module.

FIG. 9 illustrates an example of a LED light module with a back plate and an end plate.

FIGS. 10 and 21 illustrate perspective views of an example of a two-stage LED light module with a back plate and an end plate.

FIGS. 11 and 17, respectively, illustrate a right side view and a left side view of the example of the two-stage LED light module with a back plate and an end plate shown in FIG. 10.

FIGS. 12 and 13 show the perspectives of the angles θ, φ, σ, and β in a front view and a back view.

FIGS. 14 and 15, respectively, show the front view and back view of the LED light module of FIG. 5.

FIG. 16 shows an example of an application for the two-stage LED light module.

FIGS. 18 and 19, respectively, show the front view and back view of the two stage LED light module of FIG. 8.

FIG. 20 shows an example of a back plate with a cutout.

FIGS. 22 and 23, respectively, show the right side view and left side view of the LED light module of FIG. 9.

FIG. 24 shows an example of a back plate 910 for the LED light module.

FIGS. 25 and 26, respectively, show the LED light modules of FIGS. 1 and 6 mounted on back plates.

FIG. 27 shows an example of an application for the LED light module.

FIGS. 28 and 29 show the LED light module of FIG. 5 mounted on a back plate.

FIG. 30 shows the LED light module of FIG. 7 mounted on a back plate 910.

FIGS. 31 and 32, respectively, show the right side view and left side view of the LED light module of FIG. 5.

### DETAILED DESCRIPTION

The detailed description set forth below in connection with the appended drawings is intended as a description of various embodiments of the present invention and is not intended to represent the only embodiments in which the present invention may be practiced. Each embodiment described in this disclosure is provided merely as an example or illustration of the present invention, and should not necessarily be construed as preferred or advantageous over other embodiments. The detailed description includes specific details for the purpose of providing a thorough understanding of the present invention. However, it will be apparent to those skilled in the art that the present invention may be practiced without these specific details. In some instances, well-known structures and devices are shown in block diagram form in order to avoid obscuring the concepts of the present invention. Acronyms and other descriptive terminology may be used merely for convenience and clarity and are not intended to limit the scope of the invention.

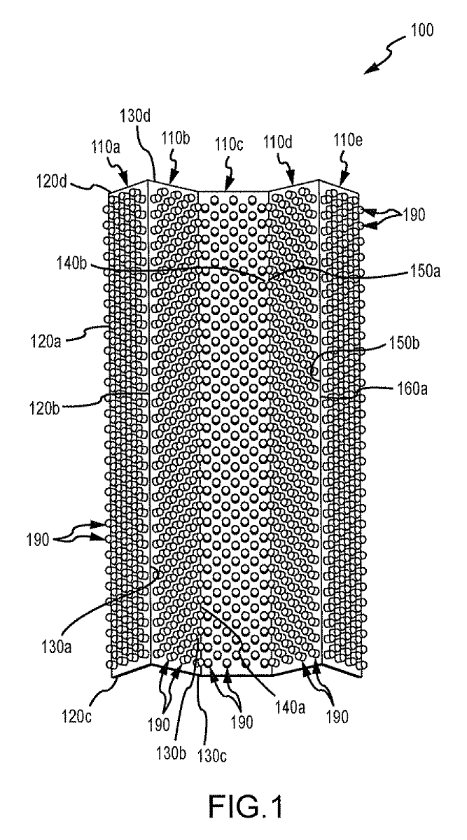

FIG. 1 is an example of a LED light module 100 comprising a plurality of printed circuit boards. In one example the LED light module comprises five printed circuit boards with a first printed circuit board 110a, a second printed circuit board 110b, a third printed circuit board 110c, a fourth printed circuit board 110d and a fifth printed circuit board 110e. A plurality of LED bulbs 190 are mounted on each of the five printed circuit boards 110a, 110b, 110c, 110d, 110e. In one aspect, the printed circuit boards are rectangular or square in shape. One skilled in the art would understand that the printed circuit boards can include a variety of shapes without affecting the scope and spirit of the present disclosure. For example, as shown in FIG. 1, printed circuit boards 110a, 110b, 110c, 110d, 110e are rectangular in shape. Each of the five printed circuit boards 110a, 110b, 110c, 110d, 110e include four edges. Printed circuit board 110a includes edges 120a, 120b, 120c, 120d. Printed circuit board 110b includes four edges 130a, 130b, 130c, 130d. Printed circuit board 110c includes four edges 140a, 140b, 140c, 140d (not all shown). Printed circuit board 110d includes four edges 150a, 150b, 150c, 150d (not all shown). Printed circuit board 110e includes four edges 160a, 160b, 160c, 160d (not all shown).

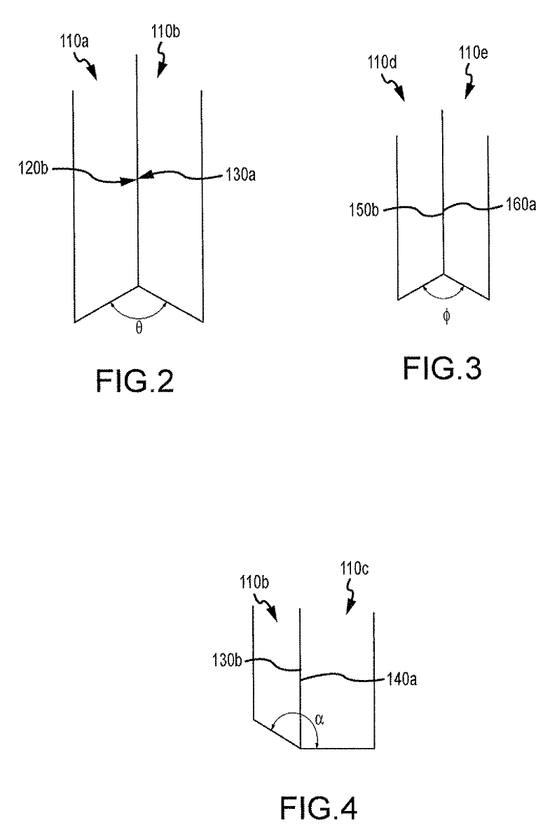

In one aspect, edge 120b of printed circuit board 110a touches edge 130a of printed circuit board 110b to form an angle θ as shown in FIG. 2. In one example, the angle θ is 30 degrees. In another example, the angle θ is 45 degrees. In yet another example, the angle θ is 60 degrees. One skilled in the art would recognized specific values of θ could be within a range of angles, such as but not limited to 15 degrees to 75 degrees, and be within the scope and spirit of the present disclosure.

In one aspect, edge 150b of printed circuit board 110d touches edge 160a of printed circuit board 110e to form an angle φ as shown in FIG. 3. In one example, the angle φ is the same as the angle θ. In another example, the angle φ is different from the angle θ. One skilled in the art would recognized specific values of φ could be within a range of angles, such as but not limited to 15 degrees to 75 degrees, and be within the scope and spirit of the present disclosure.

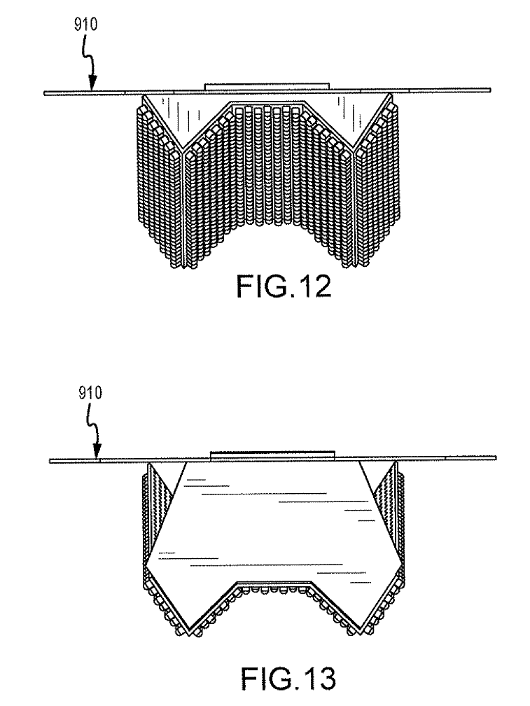

In one aspect, the edge 130b of printed circuit board 110b touches edge 140a of printed circuit 110c to form an angle α shown in FIG. 4. The angle α is measured from a plane defined by printed circuit board 110b to another plane defined by printed circuit board 110c as shown in FIG. 4. In one example, the angle α is 135 degrees. One skilled in the art would recognized specific values of α could be within a range of angles, such as but not limited to 95 degrees to 175 degrees, and be within the scope and spirit of the present disclosure. In one aspect the angle β (not shown) made by edge 140b of printed circuit board 110c with edge 150a of printed circuit board 110d has a value such as but not limited to 95 degrees to 175 degrees. The perspectives of the angles θ, φ, σ, and β discussed above can be seen from the front view and back view, respectively, in FIGS. 12 and 13.

In one aspect, the quantity of printed circuit boards in the LED light module may range from two to ten. In one aspect, the LED light module comprises printed circuit boards 110a and 110b with their adjacent edges forming an angle θ. In another aspect, the LED light module comprises of five sets of the pair of printed circuit boards 110a and 110b with adjacent edges forming an angle θ. In one aspect, the adjacent edges are touching.

In one example, the LED light module comprises of three printed circuit boards 110c, 110d and 110e. In another example, the LED light module comprises of two sets of three printed circuit boards 110c, 110d and 110e. In yet another example, the LED light module comprises of three sets of three printed circuit boards 110c, 110d and 110e. As described above, the adjacent edges of printed circuit board 110c and 110d form an angle α, while the adjacent edges of printed circuit board 110d and 110e form an angle φ.

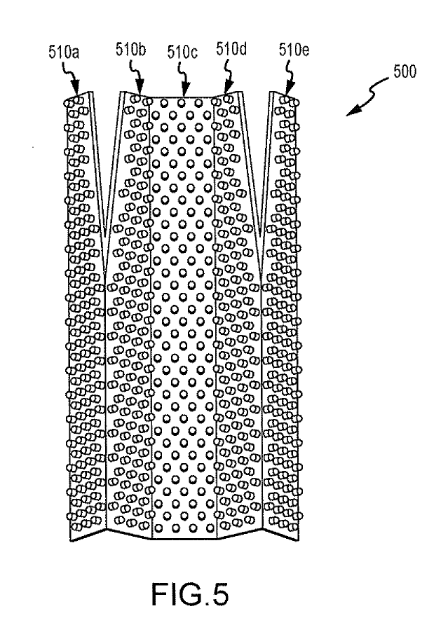

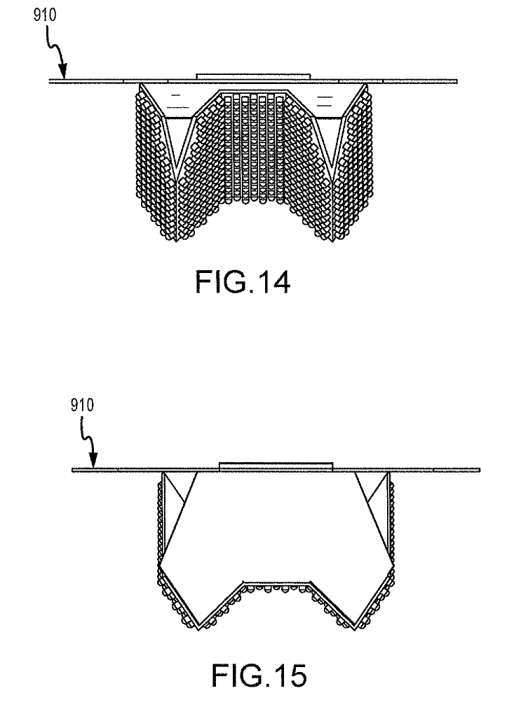

In one aspect, all the printed circuit boards in the LED light module have the same shape as shown in FIG. 1. In another aspect, the printed circuit boards in the LED light module have different shapes from each other. FIG. 5 is a front view of an example of a LED light module 500 with printed circuit boards with different shapes. In the example LED light module 500 shown in FIG. 5, printed circuit boards 510a, 510b, 510d, 510e each have a triangularly shaped cut out on one end of the printed circuit board. Printed circuit board 510c does not include a cutout. One skilled in the art would recognize that printed circuit boards with other shapes and/or cut outs that are of other different shapes may be used within the scope and spirit of the present disclosure. Similarly, the printed circuit boards 510a, 510b, 510d, 510e shown in FIG. 5 may form angles θ, φ, σ, and β in similar relationships as discussed above. FIGS. 14 and 15, respectively, show the front view and back view of the LED light module of FIG. 5.

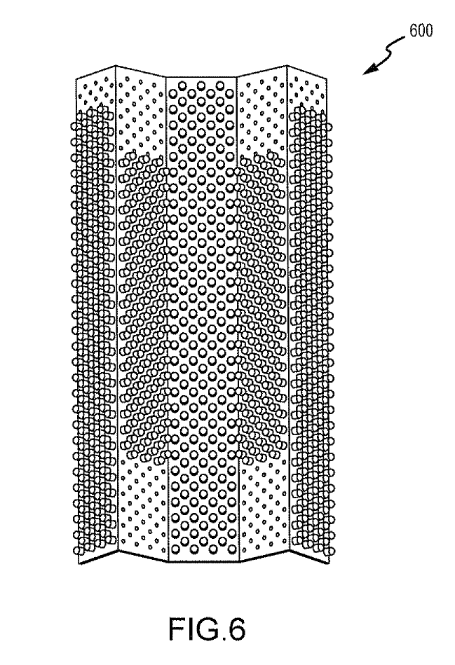

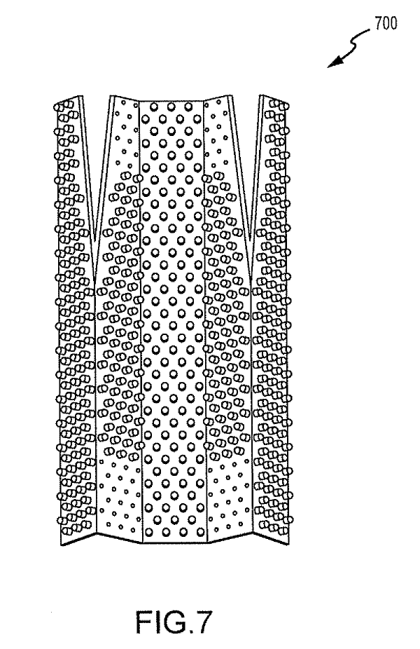

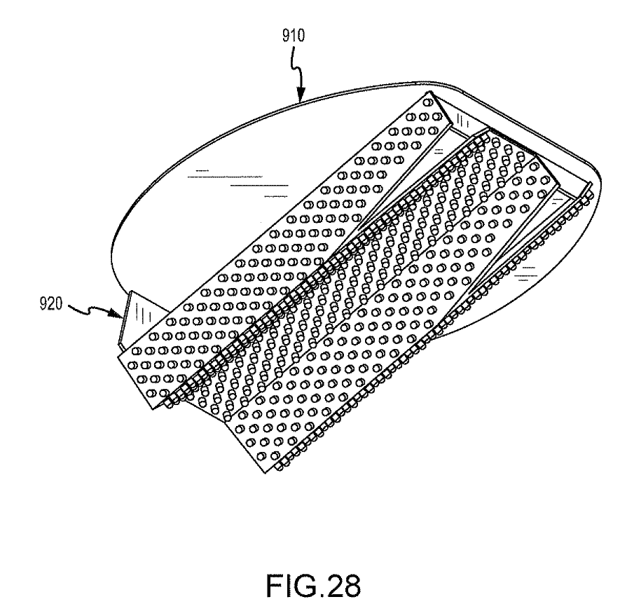

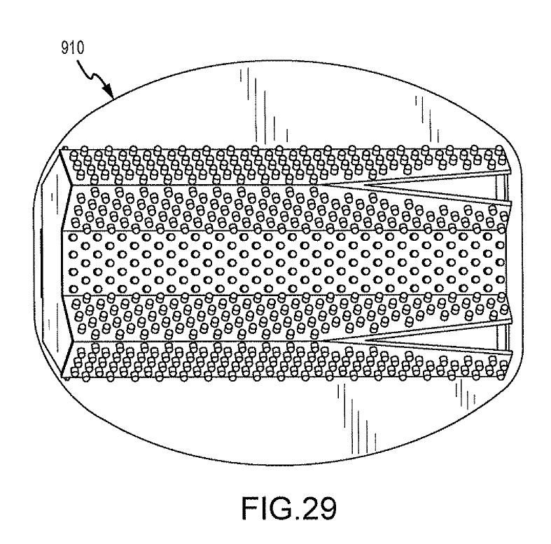

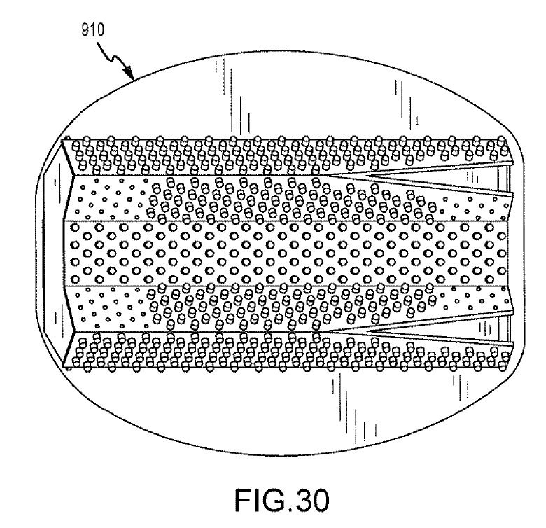

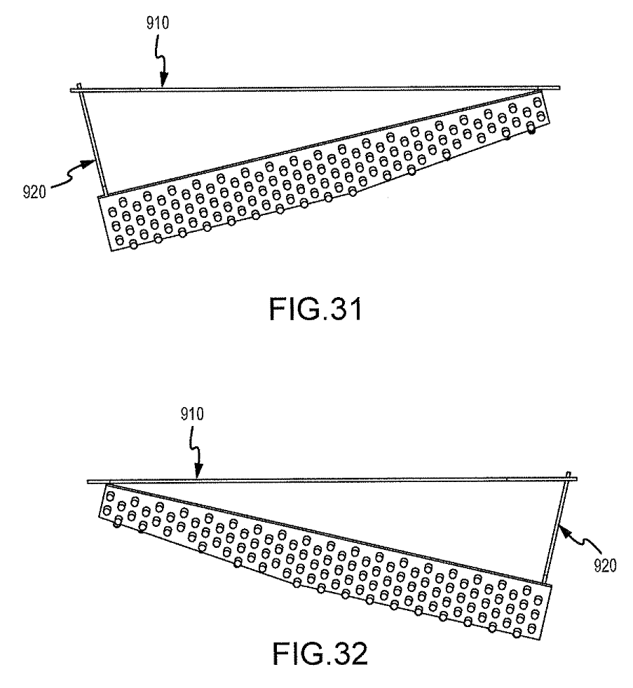

In one aspect, the LED light module comprises printed circuit boards that are fully populated with LED bulbs as shown in FIGS. 1 and 5. FIGS. 28 and 29 show the LED light module of FIG. 5 mounted on a back plate 910. FIGS. 31 and 32, respectively, show the right side view and left side view of the LED light module of FIG. 5. In another aspect, the LED light module comprises printed circuit boards that are partially populated with LED bulbs. In yet another aspect, the LED light module comprises a combination of printed circuit boards that are fully populated with LED bulbs and printed circuit boards that are partially populated with LED bulbs. FIGS. 6 and 7 illustrate two examples of two LED light modules 600, 700 with combinations of printed circuit boards that are fully populated with LED bulbs and printed circuit boards that are partially populated with LED bulbs. FIG. 30 shows the LED light module of FIG. 7 mounted on a back plate 910.

One skilled in the art would understand that an LED light module can have different percentages of its printed circuit boards populated with LED bulbs dependent on the desired illumination and other design considerations. Illumination distribution may depend on one or more of the following criteria: quantity of LED bulbs, power rating of the LED bulbs, distribution of the LED bulbs on the printed circuit board, the angles of the printed circuit board relative to one another, the angle of the LED light module, etc. One skilled in the art would recognize that the criteria listed herein are not exclusive and that other criteria not listed may impact illumination distribution.

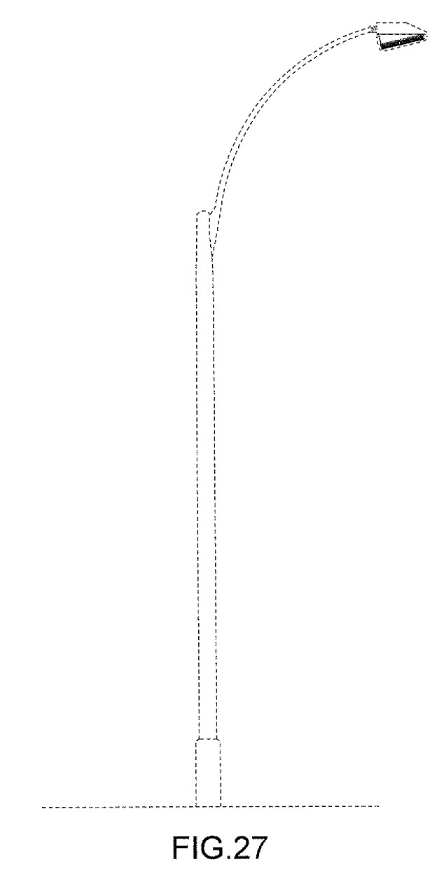

In one aspect, the printed circuit boards for each of the LED light modules shown in FIGS. 1, 5, 6 and 7 are populated with a homogenous type of LED bulbs. In another aspect, the printed circuit boards for each of the LED light modules shown in FIGS. 1, 5, 6 and 7 are populated with LED bulbs that may differ in type, power rating, efficiency, etc. For example, the LED bulbs with narrow-beam angle and/or wide-beam angle may be used. Generally, the narrower the LED beam angle, the further the emitted light may travel before losing its intensity. One skilled in the art would understand that the LED beam angle is a design parameter that is based upon the particular application. An example of an application is for the LED light module to illuminate a street and sidewalk surrounding a street post as shown in FIG. 27. One of ordinary skill in the art would recognize that the LED light module is not limited to the example of the street post, but may be adapted to other various applications, including indoor illumination.

In one aspect, the LED bulbs are mounted to the printed circuit boards in a perpendicular manner. In another aspect, the LED bulbs are mounted to the printed circuit boards at an angle. In yet another aspect, some of the LED bulbs are mounted to the printed circuit boards in a perpendicular manner while other LED bulbs are mounted to the printed circuit boards at one or more angles. In one aspect, the LED bulbs form an angle between 30 degrees and 60 degrees relative to the plane of the printed circuit board on which it is mounted. In one aspect, the minimum value of the angle is limited by the physical characteristics of the LED bulbs. For example the physical circumference of the LED bulbs limits the minimum value of the angle at which the LED bulbs can be mounted onto the printed circuit boards while directing its illumination toward the ground. For example, the LED bulbs' height dimension will also limit the minimum value of the angle. Accordingly, the LED bulbs can only be angled toward the ground at a certain angle before it physically blocks a nearby LED bulb above or below it. Thus, one skilled in the art would understand that the minimum value of the angle is a design parameter dependent on various factors, such as but not limited to the dimensions of the LED bulbs. In one aspect, the angle is about 45 degrees.

Although the printed boards shown in the LED light modules of FIGS. 1, 5, 6 and 7 are shown to be touching, in one aspect, the printed boards are spaced apart from each other, but keep the angle relation described in the present disclosure above.

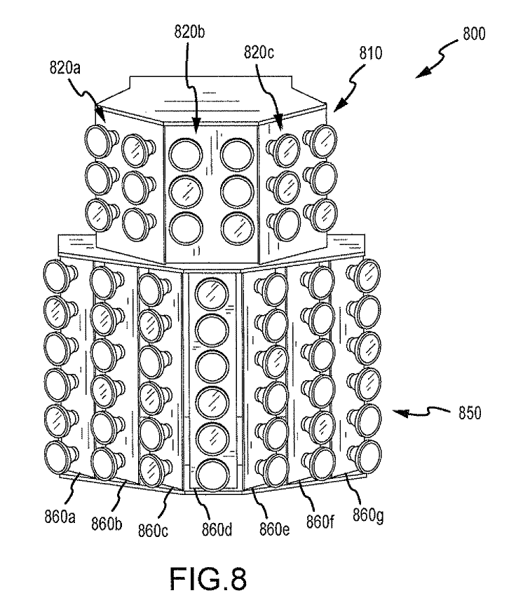

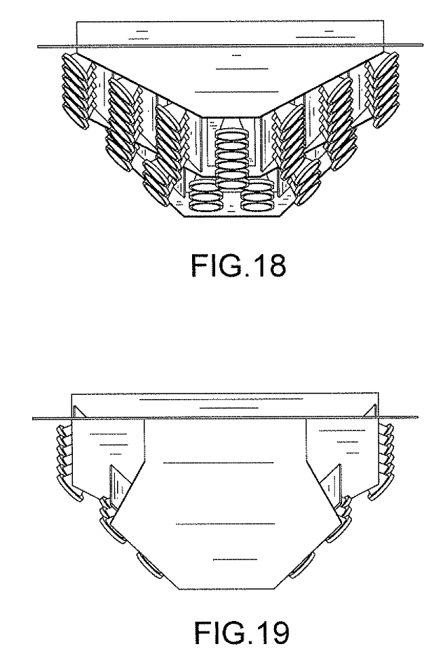

FIG. 8 illustrates an example of a two stage LED light module 800 comprising of a top stage 810 and a bottom stage 850. FIGS. 18 and 19, respectively, show the front view and back view of the two stage LED light module of FIG. 8. In one example, the top stage 810 comprises three printed circuit boards 820a, 820b, 820c on which a plurality of LED bulbs is mounted. In one aspect, the three printed circuit boards 820a, 820b, 820c each include at least one edge that touches another edge of its adjacent printed circuit board. In another aspect (not shown), the three printed circuit boards 820a, 820b, 820c do not touch and a space is located between each of the three printed circuit boards 820a, 820b, 820c.

In one example, the bottom stage 850 comprises seven printed circuit boards 860a, 860b, 860c, 860d, 860e, 860f, 860g on which a plurality of LED bulbs is mounted. In one aspect (as shown in FIG. 8), the seven printed circuit boards 860a, 860b, 860c, 860d, 860e, 860f, 860g do not touch and a space is located between each of the seven printed circuit boards 860a, 860b, 860c, 860d, 860e, 860f, 860g. In another aspect (not shown), the seven printed circuit boards 860a, 860b, 860c, 860d, 860e, 860f, 860g each includes at least one edge that touches another edge of its adjacent printed circuit board. One skilled in the art would understand that different combinations of different aspects of the top stage and bottom stage are possible without affecting the spirit and scope of the present disclosure.

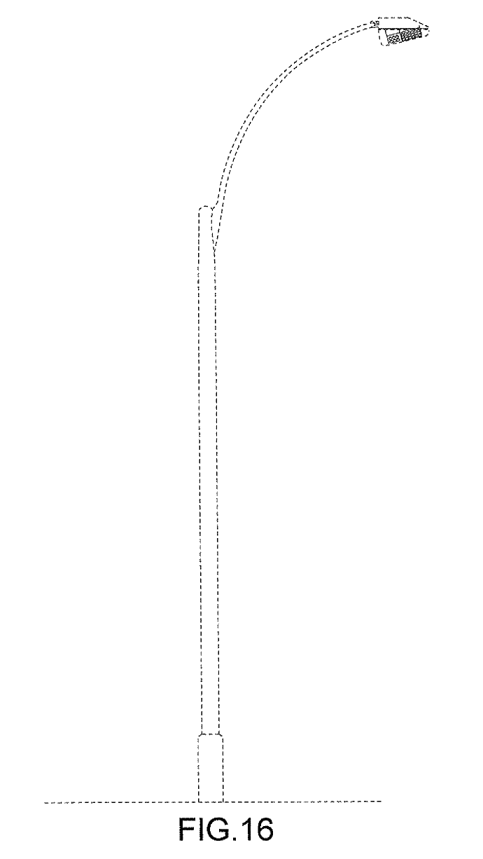

In one aspect, two-stage LED light module includes printed circuit boards that are arranged such that they are angled relative to at least one other adjacent printed circuit board. In one aspect, the two-stage LED light module includes printed circuit boards that are fully populated with LED bulbs. In another aspect, the two-stage LED light module includes printed circuit boards that are partially populated with LED bulbs. In yet another aspect, the two-stage LED light module includes printed circuit boards that are fully populated with LED bulbs and printed circuit boards that are partially populated with LED bulbs. One skilled in the art would understand that the two-stage LED light module can have different percentages of its printed circuit boards populated with LED bulbs dependent on the desired illumination and other design considerations. Additionally, different types or classifications of LED bulbs may be used in the two-stage LED light module. For example, the LED bulbs with narrow-beam angle and/or wide-beam angle may be used. An example of an application is for the two-stage LED light module to illuminate a street and sidewalk surrounding a street post as shown in FIG. 16. One of ordinary skill in the art would recognize that the two-stage LED light module is not limited to the example of the street post, but may be adapted to other various applications, including indoor illumination.

In one aspect, the LED bulbs are mounted to the printed circuit boards in a perpendicular manner. In another aspect, the LED bulbs are mounted to the printed circuit boards at an angle. In yet another aspect, some of the LED bulbs are mounted to the printed circuit boards in a perpendicular manner while other LED bulbs are mounted to the printed circuit boards at one or more angles. In one aspect, the LED bulbs form an angle between 30 degrees and 60 degrees relative to the plane of the printed circuit board on which it is mounted. In one aspect, the minimum value of the angle is limited by the physical characteristics of the LED bulbs. For example the physical circumference of the LED bulbs limits the minimum value of the angle at which the LED bulbs can be mounted onto the printed circuit boards while directing its illumination toward the ground. For example, the LED bulbs' height dimension will also limit the minimum value of the angle. Accordingly, a LED bulb can only be angled toward the ground at a certain angle before it physically blocks a nearby LED bulb above or below it. Thus, one skilled in the art would understand that the minimum value of the angle is a design parameter dependent on various factors, such as but not limited to the dimensions of the LED bulbs. In one aspect, the angle is about 45 degrees.

In one aspect, the printed circuit boards, as described herein, are replaced with non-conductive plates with electrical conductive paths connecting the plurality of LED bulbs to at least one power source.

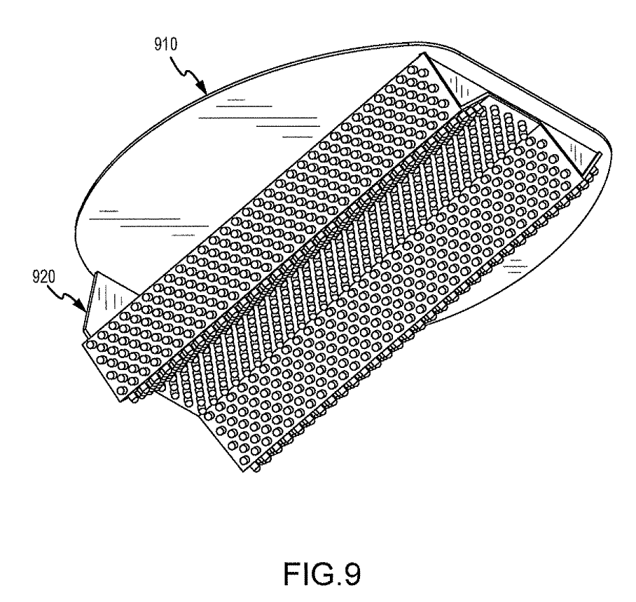

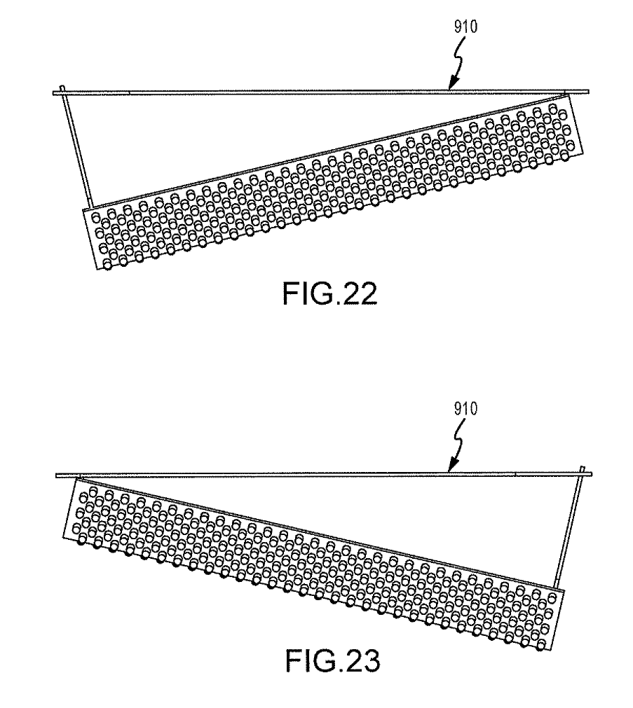

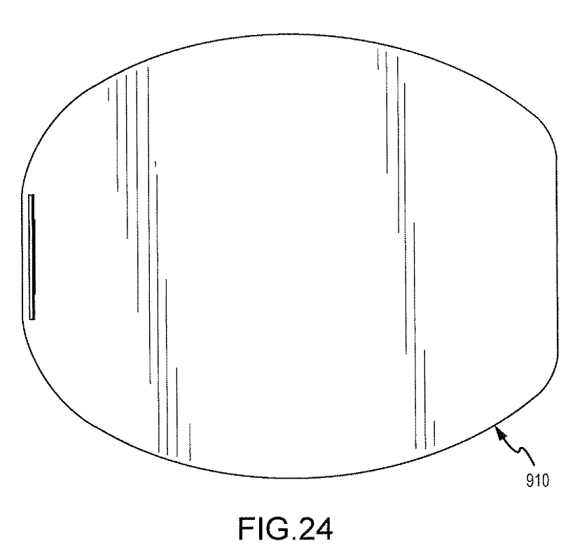

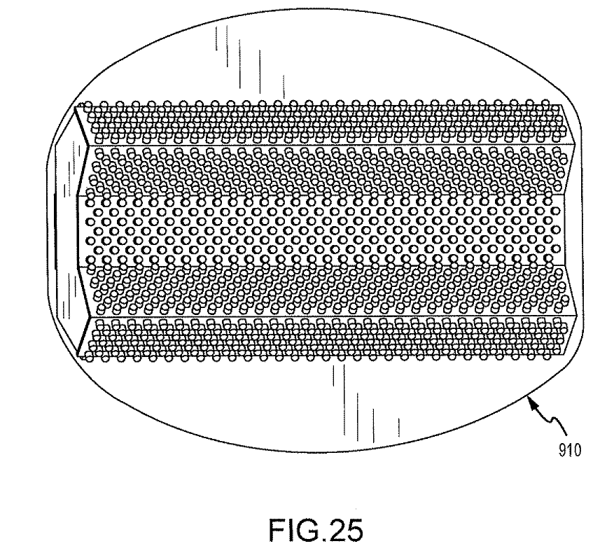

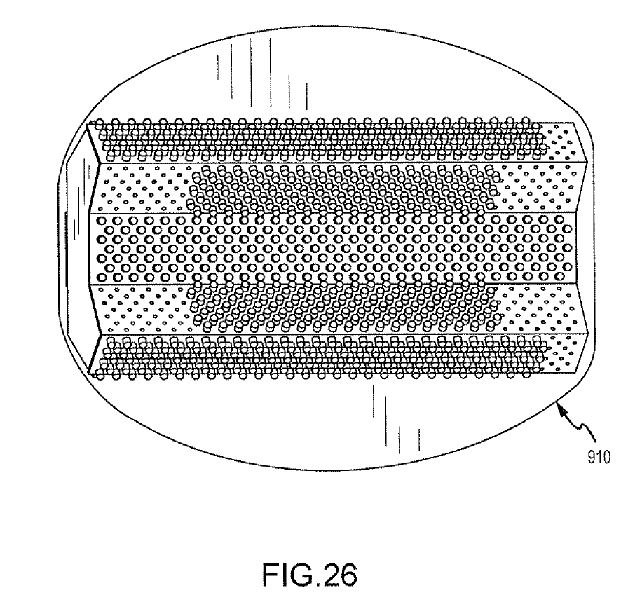

In one aspect, the LED light module is embodied in a housing which comprises a power supply to regulate power to the LED bulbs and a temperature regulation device within the housing to dissipate heat. One skilled in the art would understand that different types of power supplies (such as, but not limited to, constant current or constant voltage types) and different types of temperature regulation devices can be used within the spirit and scope of the present disclosure. As shown in FIG. 9, in one aspect, the housing includes a back plate 910 on which the LED light module is mounted. The right side view and left side view of the LED light module of FIG. 9 are shown in FIGS. 22 and 23. The housing includes at least one end plate 920 attached to the LED light module at one end to provide an angle tilt. In one aspect, the housing includes a cover plate (not shown) covering over the front side of the LED light module. FIG. 24 shows an example of a back plate 910 for the LED light module. FIGS. 25 and 26, respectively, show the LED light modules of FIGS. 1 and 6 mounted on back plates 910.

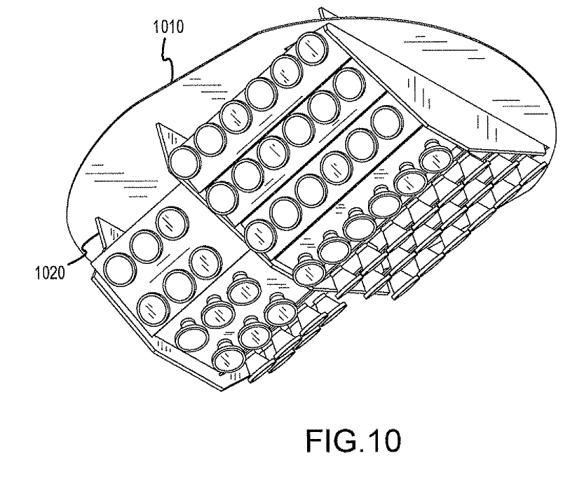

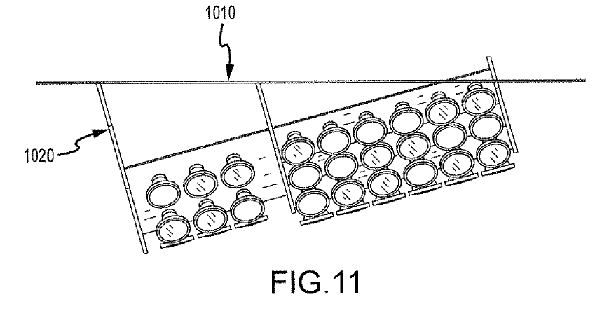

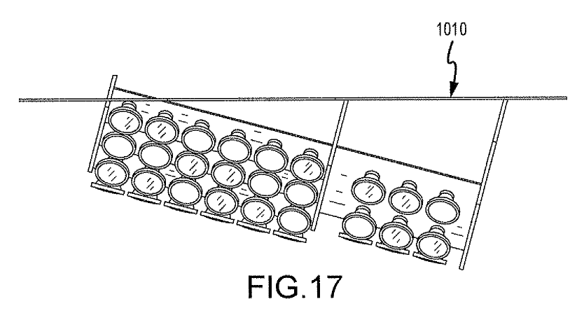

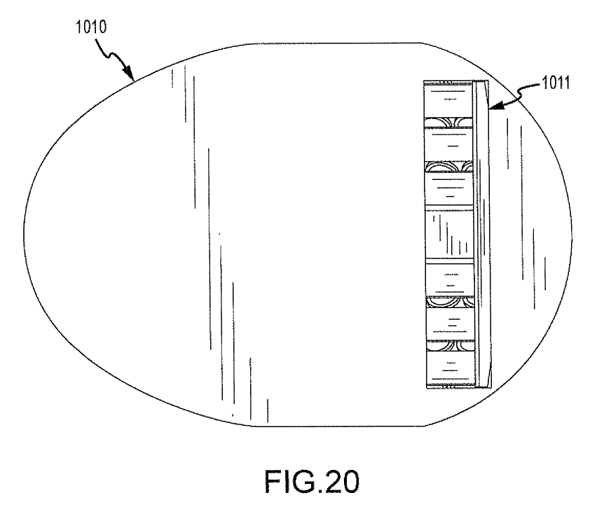

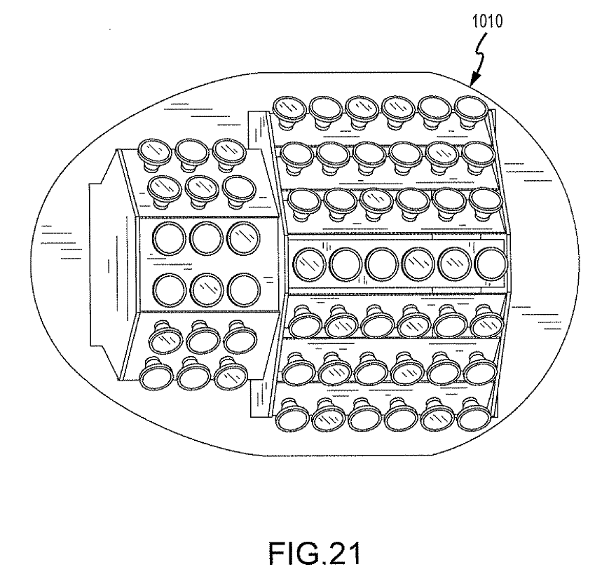

In one aspect, the two-stage LED light module is embodied in a housing which comprises a power supply to regulate power to the LED bulbs and a temperature regulation device within the housing to dissipate heat. As shown in FIGS. 10, 11, 17 and 21, in one aspect, the housing includes a back plate 1010 on which the two-stage LED light module is mounted. FIGS. 11 and 17, respectively, show the right side view and left side view of the two stage LED light module of FIG. 10. FIG. 20 shows an example of the back plate 1010 with a cutout 1011. The housing includes at least one end plate 1020 attached to the two-stage LED light module at one end to provide an angle tilt. In one aspect, the housing includes a cover plate (not shown) covering over the front side of the LED light module.

In one aspect, the temperature regulation device, for example, may be an air circulation device such as a fan or a heat transfer device such as a heat sync. The temperature regulation device uniformly dissipates heat collected within the housing to reduce local hot spots. Regulating heat dissipation can promote longer life span of the LED bulbs.

In one example, the LED light module with its housing is mounted to a street post. In one example, the two-stage LED light module with its housing is mounted to a street post.

The previous description of the disclosed embodiments is provided to enable any person skilled in the art to make or use the present invention. Various modifications to these embodiments will be readily apparent to those skilled in the art, and the generic principles defined herein may be applied to other embodiments without departing from the spirit or scope of the invention.

1. A LED light module comprising:
at least two printed circuit boards arranged at an angle relative to each other; and
a plurality of LED bulbs mounted on the at least two printed circuit boards, wherein the at least two printed circuit boards and the plurality of LED bulbs form a single light source.

2. A LED light module comprising:
a top stage comprising a first set of plurality of plates;
a bottom stage comprising a second set of plurality of plates;
a first plurality of LED bulbs mounted on the first set of plurality of plates; and
a second plurality of LED bulbs mounted on the second set of plurality of plates,
wherein at least one of the first set of plurality of plates is arranged at an angle relative to another of the first set of plurality of plates, and wherein at least one of the second set of plurality of plates is arranged at an angle relative to another of the second set of plurality of plates to form a single light source.
